(19) United States
(12) Patent Application Publication
(10) Pub. No.: US 2021/0168376 A1
(43) Pub. Date: Jun. 3, 2021

(54) METHOD, DEVICE, AND STORAGE MEDIUM FOR ENCODING VIDEO DATA BASE ON REGIONS OF INTERESTS

(71) Applicant: SZ DJI TECHNOLOGY CO., LTD., Shenzhen City (CN)

(72) Inventors: Lei ZHU, Shenzhen City (CN); Wenjun Zhao, Shenzhen City (CN); Wenyi Su, Shenzhen City (CN); Liang Zhao, Shenzhen City (CN)

(73) Assignee: SZ DJI TECHNOLOGY CO., LTD., Shenzhen City (CN)

(21) Appl. No.: 17/171,274

(22) Filed: Feb. 9, 2021

Related U.S. Application Data
(63) Continuation of application No. PCT/CN2019/089989, filed on Jun. 4, 2019.

(51) Int. Cl. H04N 19/167; H04N 19/176; H04N 19/124; B64C 39/02

(52) U.S. Cl. CPC H04N 19/167; H04N 19/176; B64C 2201/122; B64C 39/024; B64C 2201/127; H04N 19/124

(57) ABSTRACT

An unmanned aerial vehicle comprises a body coupled with a plurality of propulsion systems and an imaging device; an encoder that encodes video data generated by the imaging device, and a wireless communication system for transmitting the encoded video data. The encoder includes a region of interest (ROI) control module that determines, within an image frame of the video data, a first region and a second region, the ROI control module further setting a first limit indicating a maximum value of quantization parameters for encoding each macroblock within the first region, a second limit indicating a maximum size of the first region, and a third limit indicating a minimum size of the second region. The encoder further includes a ROI monitoring module coupled to the ROI control module that estimates a first image quality of the first region and a second image quality of a second region, and the ROI control module adjusts a size of the first region and the second region according to the first image quality and the second image quality. The present application also relates to an encoding method as embodied in the encoder.

### RELATED APPLICATIONS

This application is a continuation of PCT Application No. PCT/CN2019/089989, filed Jun. 4, 2019, which is hereby incorporated by reference in its entirety.

### TECHNICAL FIELD

The present disclosure generally relates to video processing and, more particularly, to video encoding.

### BACKGROUND

Imaging devices with high definition (HD), ultrahigh definition (UHD), and even higher resolutions have been widely incorporated into many other systems for the purposes of visual perception and documentation. Examples of systems having a high-definition imaging device include computers, tablets, phones, general photography systems, surveillance systems, home security systems, and unmanned aerial vehicles. In many applications, video data captured by the imaging devices is streamed via a wired or wireless network to a remote terminal for inspection and control in real-time. Video streaming applications require a low latency transmission with acceptable image quality. As the transmission of video data, even compressed, may sometimes exceeds the capacity of the bit rate of a network, especially a wireless network, appropriate rate control techniques, such as techniques based on the regions of interest (ROI), are used to encode a video data such that the ROIs are encoded with a higher quality than non-ROIs. In this way, a balance between a latency requirement and an image quality of the encoded video data may be achieved,

ROI-based encoding methods have spurred a great deal of interests in the field of aerial reconnaissance and surveillance mainly because these missions have to rely on a wireless network to transmit video data at a low latency. For example, unmanned aerial vehicles (“UAVs”) equipped with high definition imaging devices are widely used in tasks ranging from surveillance to tracking, remote sensing, search and rescue, scientific research, and the like. In a typical operation, an operator controls a UAV to fly over a concerned area while the UAV continues capturing videos with its imaging devices and transmits the same wirelessly to the operator's terminal for inspection. It is important that the video data is transmitted with very low latency and high quality so that the operator can rely on the transmitted videos to make instant decisions. But sometimes, it is challenging to transmit an entire image with high definition at a low latency due to the limit of the bandwidth available in the wireless communication channel. One way to overcome this challenge is to separate the image into ROIs (region of interests to an operator) and non-ROIs (regions of no interests to an operator) and transmits the ROIs with a high quality while the non-ROIs are transmitted with a lower quality.

In the application of FPV (first person view) drone racing, a head-mounted display is used to display videos streamed by a racing drone in real time, and players rely on the head-mounted display to make a decision on how to control small aircrafts in a high speed chase that requires sharp turns around obstacles. As the speed of a racing drone could reach a few hundred kilometers per hour, the video displayed to the player needs to be transmitted at a latency that is less than one frame rate so that the play may not be mislead by a delayed video. For example, when a drone is traveling at a speed of 360 km/hr, it would take only 0.01 second to travel one meter. To control such a high speed drone, not only the frame rate of the image capturing device needs to be very high, such as 120 frame/second, both the encoding of the video data and transmission of the video data need to be completed in a period shorter than one frame rate. Otherwise, what the player sees on the display may have been a few meters away from the actual location of a racing drone.

Traditional ROI encoding methods typically establish a fixed ROI and then set a quality differential between a ROI and a non-ROI. Several drawbacks are caused by this kind of ROI encoding methods. For example, these methods typically set the quality of a ROI to be relatively higher than a non-ROI, but cannot guarantee that the ROI has a quality that meets the needs of a specific application. In addition, when the bandwidth of a wireless communication channel fluctuates due to the change of distance, interference, and landscapes, these traditional methods fail to make necessary adjustments to adapt the ROI to the present states of a wireless communication channel. Furthermore, ROIs may not always include an image region having a complex context. When ROIs have simple context while non-ROIs have relatively complex context, traditional ROI-based encoding methods sometimes produce a blocking effect of non-ROIs, which produces very little details of non-ROIs, because non-ROIs are forced to have a lower quality than ROIs by a fixed amount.

### SUMMARY

An objective of the present application is to provide a video encoding method that ensures ROIs to be encoded with a high quality that can robustly resist any negative impact of the quality due to fluctuation of the bandwidth. Another objective of the present application is to reduce the potential blocking effect in the encoded data of non-ROIs. Yet another objective is to produce ROIs as large as possible under constraints of available bandwidth so that a displayed image frame has large regions of high image quality.

The present application ensures the quality of ROIs by setting an upper limit of the quantization parameters of ROIs so that ROIs has a relatively stable image quality. The present application is also capable of dynamically adjusts other parameters of ROI, such as the size of ROIs, to balance the quality across the entire image. In this way, the ROIs are enlarged when non-ROIs still has acceptable image quality. When the non-ROIs' image quality is very low, the size of ROIs may be reduced to save more bit rates for the non-ROIs. Whether to adjust the size of ROIs depends on a comparison of the image quality between ROIs and non-ROIs.

According to an aspect, the present application is directed to a method for encoding video data. The method comprises receiving video data generated by an imaging device, determining, within an image frame of the video data, a first region and a second region; setting a first limit indicating a maximum value of quantization parameters for encoding each macroblock within the first region, a second limit indicating a maximum size of the first region, and a third limit indicating a minimum size of the first region; estimating a first image quality of the video data of the first region and a second image quality of the video data of the second region; adjusting sizes of the first region and the second region according to the first image quality and the second image quality; and encoding the video data.

According to various embodiments, the encoding method further comprises calculating a first statistical value based on quantization parameters of each macroblock within the first region as the first image quality and calculating a second statistical value based on quantization parameters of each macroblock within the second region as the second image quality. When the second image quality is greater than the first image quality, the encoding method increases the size of the first region by a predetermined length. When the size of the first region reaches the second limit and the second image quality is greater than the first image quality, the encoding method reduces the first limit by a predetermined amount.

According to various embodiments, when the second image quality is lower than the first image quality by a predetermined threshold, the encoding method reduces the size of the first region by a predetermined length. When the size of the first region reaches the third limit and the second image quality is lower than the first image quality by the predetermined threshold, the encoding method increases the first limit by a predetermined amount. When the second image quality is not lower than the first image quality by the predetermined threshold, the encoding method keeps both the size of the first region and the first limit unchanged.

According to another embodiment, the first region represents a rectangle of a predetermined size that surrounds a center of the image frame, and a combination of the first region and second region occupies a full image frame.

According to another embodiment, the encoding method further implements an object recognition algorithm to determine the first region, estimates a first bit rate of the encoded data corresponding to the first region by encoding the first region, calculates a second bit rate of the second region based on the first bit rate and an available bandwidth of the wireless communication system; and encodes video data of the second region to fit the target bit rate.

Another aspect of the present application is directed to a non-transitory storage medium storing an executable program which, when executed, causes a processor to implement the encoding method as set forth in the present application.

Another aspect of the present application is directed to an unmanned vehicle system comprising a body coupled to a propulsion system and an imaging device, an encoder for encoding video data generated by the imaging device, and a wireless communication system for transmitting the video data encoded by the encoder. The encoder implements the encoding method as set forth in the present application.

### BRIEF DESCRIPTION OF THE DRAWINGS

The above and other objects, features, and advantages of various embodiments as set forth in the present disclosure will be more apparent from the following detailed description of embodiments taken in conjunction with the accompanying drawings.

FIG. 1 illustrates a video encoding system according to an embodiment of the present application.

FIG. 2 illustrates an exemplary structure of a movable object according to an embodiment of the present application.

FIG. 3 illustrates an encoder according to an embodiment of the present application.

FIG. 4 illustrates an encoder according to an embodiment of the present application.

FIG. 5 illustrates a ROI monitoring method according to an embodiment of the present application.

FIG. 6 illustrates a ROI controlling method according to an embodiment of the present application.

FIG. 7 illustrates a work example of an encoding method according to an embodiment of the present application.

FIG. 7A illustrates an original image with a ROI region according to an embodiment of the present application.

FIG. 7B illustrates the improvement of the image quality in the ROI by the ROI based method over the traditional method according to an embodiment of the present application.

FIG. 7C illustrates the image quality adjustment of non-ROI between the ROI based method and the traditional encoding method according to an embodiment of the present application.

FIG. 8 illustrates adjustments of the size of ROIs according to an embodiment of the present application.

FIG. 9 illustrates an electronic device for implementing the encoding method according to an embodiment of the present application.

### DETAILED DESCRIPTION

It will be appreciated by those ordinarily skilled in the art that the foregoing brief description and the following detailed description are exemplary (i.e., illustrative) and explanatory of the subject matter as set forth in the present disclosure, but are not intended to be restrictive thereof or limiting of the advantages that can be achieved by the present disclosure in various implementations.

It is noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like.

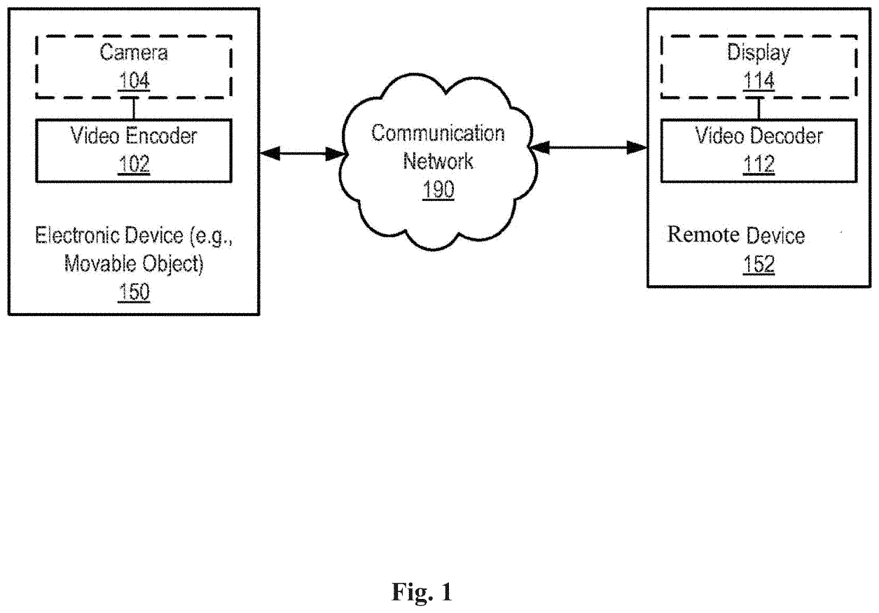

FIG. 1 illustrates a video transmission system according to an embodiment of the present application. The video transmission system includes an electronic device 150, a communication network 190, and a remote device 152. The electronic device 150 may be any device that is capable of processing video data, such as a computer, a server, a terminal, a tablet, a phone, an unmanned vehicle with a camera, and a UAV with a camera. The remote device 152 may be a mobile terminal, such as a phone, a tablet, a remote control with a display, or a wearable goggle with a display. The communication network 190 may include both wired and wireless communication channels. When a wireless communication channel is used, it may deploy technologies such as wireless local area network (WLAN) (e.g., WiFi™), Bluetooth, and the third/fourth/fifth generation (3G/4G/5G) cellular network.

The electronic device 150 includes an imaging device, such as a camera 104, connected with a video encoder 102. The camera 104 captures images and/or video, which are further encoded by the video encoder 102 and then output for transmission. While only one camera is illustrated in FIG. 1, it is to be understood that the electronic device 150 may work with multiple cameras. In one embodiment, the captured images and/or video are encoded and stored at the electronic device 150. The stored video/image may be transmitted to another device, such as the remote device 152, based on several triggering events, such as a scheduling policy, an operator's request (e.g., the operator of the electronic device 150) and/or network characteristics (e.g., a wired connection and/or a bandwidth of the available connections). In another embodiment, the captured images and/or video are streamed to the remote device 152 via a wireless communication channel. In a preferred embodiment, the latency of the streamed video needs to be close to or less than one frame rate of the video data to allow the operator make a real-time decision based on the received video data. The term “latency” as used in the present application refer to the time period from capturing a frame image to displaying the frame image on a remote terminal, including the process of capturing, encoding, transmission, decoding, and displaying the image frame.

It is to be noted that encoding technologies for encoding video data is also suitable for encoding image data, as video data is understood as being formed by a plurality of image frames, each being an image. Thus unless noted otherwise, the operations disclosed in this specification that are performed on video data apply to still image data too. Additionally, a camera may capture audio data, positional data along with the pictorial data. The video data as discussed in this specification may also include video data, audio data, positional data, and other information captured by one or more cameras.

The encoded data is transmitted to the remote device 152 through the communication network 190. At the remote device 152, the encoded data is decoded by a video decoder 112. The decoded data can then be shown on a display 114 of the remote device 152. When the encoded data includes audio data, the decoded audio data can be listened to from a speaker (not shown), singly or along with the display.

The video encoder 102 and video decoder 112 together are often referred to as a codec system. A codec system may support one or more video compression protocols. For example, the codec in the video communication environment of FIG. 1 may support one or more of H.265 high efficiency video coding (HEVC), H.264 advanced video coding (AVC), H.263, H.262, Apple ProRes, Windows Media Video (WMV), Microsoft (MS) Moving Picture Experts Group (MPEG)-4v3, VP6-VP9, Sorenson, RealVideo, Cinepak, and Indeo. Embodiments of the present application are not limited to a particular video compression protocol and are applicable to video compression protocols that support slice encoding.

In one embodiment, the electronic device 150 is a mobile device. For example, the electronic device 150 may be a wearable electronic device, a handheld electronic device, or a movable object, such as an UAV. When the electronic device 150 is an UAV, the camera 104 may be an onboard camera, which takes aerial photographs and video for various purposes such as industrial/agricultural inspection, live event broadcasting, scientific research, racing, and etc.

The camera 104 is capable of providing video data in 4K resolution, which has 4096×2160 or 3840×2160 pixels. Embodiments of the present application may also encode video data in other resolutions such as standard definition (SD) (e.g., 480 lines interlaced, 576 line interlaced), full high definition (FHD) (e.g., 1920×1080 pixels), 5K UHD (e.g., 5120×2880, 5120×3840, 5120×2700 pixels), and 8K UHD (e.g., 7680×4320, 8192×5120, 10240×4320 pixels).

In an embodiment, the camera 104 is capable of generating video data at a high frame rate, such as 60 Hz, 120 Hz, or 180 Hz. The electronic device 150 is configured to encode the generated video data in real-time or near real-time. In one embodiment, the encoding method is capable of encoding video data with very low latency, such as about 100 ms or 20 ms. A target latency may be designed according to the application of the encoding process and the frame rate of the captured video data. For example, if the encoding process is used for a streaming of a live video, then the target latency for transmitting the video data needs to be about or shorter than the frame rate. If the latency is much longer than the frame rate, an operator would have to rely on a much delayed video image to control a UAV, thus having a higher likelihood to crash the UAV. According to an embodiment, when the frame rate of the captured video is 120 Hz, the latency that is achievable by the present application may be as low as 20 ms.

While only one video encoder is illustrated, the electronic device 150 may include multiple video encoders that encode video data from the camera 104 or a second camera. The encoding process of the video encoder 102 will be disclosed in detail in the following sections of this application.

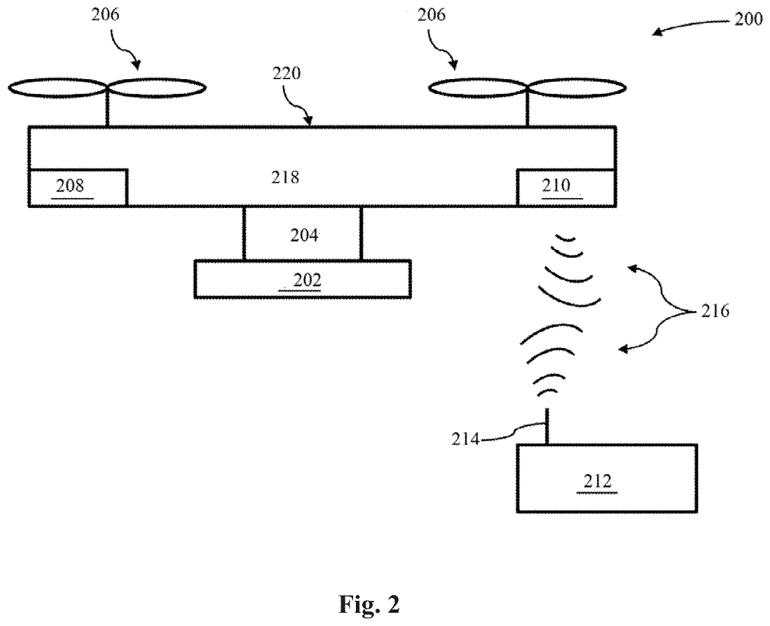

FIG. 2 illustrates an embodiment of an exemplary aerial system 200 as a movable object 150. The aerial system 200 may be an aircraft having a fixed wing or a rotary propeller. The aerial system may have a pilot or may be a UAV that is controlled remotely by an operator. An example of a UAV may be a Phantom drone or a Mavic drone manufactured by DJI. The aerial system may carry a payload 202. In one embodiment, the payload 202 includes an imaging device, such as a camera 104 as shown in FIG. 1. A carrier 204 may be used to attach the payload 202 to the body 220 of the aerial system 200. In one embodiment, the carrier 204 includes a three-axis gimbal.

The aerial system 200 may include a plurality of propulsion mechanisms 206, a sensing system 208, a communication system 210, and a plurality of electrical components 216 housed inside the body 220 of the aerial system. In one embodiment, the plurality of electrical components 218 includes the video encoder 102 as shown in FIG. 1. In another embodiment, a video encoder may be placed inside the payload 202.

The propulsion mechanisms 206 can include one or more of rotors, propellers, blades, engines, motors, wheels, axles, magnets, or nozzles. In some embodiments, the propulsion mechanisms 206 can enable the aerial system 200 to take off vertically from a surface or land vertically on a surface without requiring any horizontal movement of the aerial system 200 (e.g., without traveling down a runway). The sensing system 208 can include one or more sensors that may sense the spatial disposition, velocity, and/or acceleration of the aerial system 200 (e.g., with respect to up to three degrees of translation and up to three degrees of rotation). The one or more sensors can include global positioning system (GPS) sensors, motion sensors, inertial sensors, proximity sensors, or image sensors.

The communication system 210 enables communication with a terminal 212 having a communication system 214 via a wireless channel 216. The communication systems 210 and 214 may include any number of transmitters, receivers, and/or transceivers suitable for wireless communication.

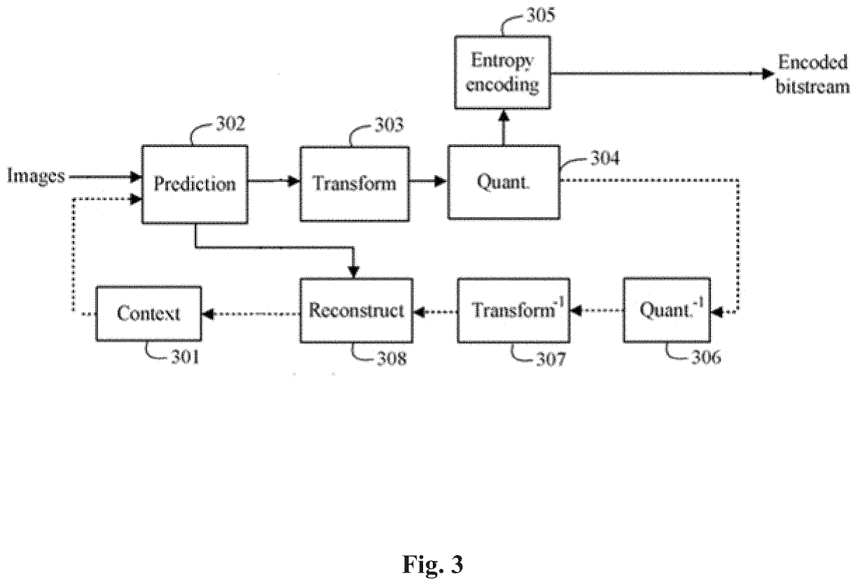

FIG. 3 illustrates an embodiment of an encoding system according to the present application. As shown in FIG. 3, the encoder includes a “forward path” connected by solid-line arrows and an “inverse path” connected by dashed-line arrows in the figure. The “forward path” includes conducting an encoding process on an entire image frame, a region of the image frame, or a block of the image frame, such as a macroblock (MB). The “inverse path” includes implementing a reconstruction process, which generates context 301 for the prediction of a next image frame or a next block of the next image frame. Hereinafter, the terms “frame,” “image,” and “image frame” are used interchangeably.

A macroblock of an image frame may be determined according to a selected encoding standard. For example, a fixed-sized MB covering 16×16 pixels is the basic syntax and processing unit employed in H.264 standard. H.264 also allows the subdivision of a MB into smaller sub-blocks, down to a size of 4×4 pixels, for motion-compensation prediction. A MB may be split into sub-blocks in one of four manners: 16×16, 16×8, 8×16, or 8×8. The 8×8 sub-block may be further split in one of four manners: 8×8, 8×4, 4×8, or 4×4. Therefore, when H.264 standard is used, the size of the block of the image frame can range from 16×16 to 4×4 with many options between the two as described above.

In some embodiments, as shown in FIG. 3, the “forward path” includes a prediction module 302, a transformation module 303, a quantization module 304, and an entropy encoding module 305. In the prediction module 302, a predicted block can be generated according to a prediction mode. The prediction mode can be selected from a plurality of intra-prediction modes and/or a plurality of inter-prediction modes that are supported by the video encoding standard that is employed. Taking H.264 for an example, it supports nine intra-prediction modes for luminance 4×4 and 8×8 blocks, including eight directional modes and an intra direct component (DC) mode that is a non-directional mode. For luminance 16×16 blocks, H.264 supports four intra-prediction modes, such as vertical mode, horizontal mode, DC mode, and plane mode. Furthermore, H.264 supports all possible combination of inter-prediction modes, such as variable block sizes (i.e., 16×16, 16×8, 8×16, 8×8, 8×4, 4×8, 4×4) used in inter-frame motion estimation, different inter-frame motion estimation modes (i.e., use of integer, half, or quarter pixel motion estimation), and multiple reference frames.

In the plurality of intra-prediction modes, the predicted block is created using a previously encoded block from the current frame. In the plurality of inter-prediction modes, the previously encoded block from a past or a future frame (a neighboring frame) is stored in the context 301 and used as a reference for inter-prediction. In some embodiments, a weighted sum of two or more previously encoded blocks from one or more past frames and/or one or more future frames can be stored in the context 301 for inter-prediction. The predicted block is subtracted from the block to generate a residual block.

In the transformation module 303, the residual block is transformed into a representation in a spatial-frequency domain (also referred to as a spatial-spectrum domain), in which the residual block can be expressed in terms of a plurality of spatial-frequency domain components, e.g., cycles per spatial unit in X and Y directions. Coefficients associated with the spatial-frequency domain components in the spatial-frequency domain expression are also referred to as transform coefficients. Any suitable transformation method, such as a discrete cosine transform (DCT), a wavelet transform, or the like, can be used here. Taking H.264 as an example, the residual block is transformed using a 4×4 or 8×8 integer transform derived from the DCT.

In the quantization module 304, quantized transform coefficients can be obtained by dividing the transform coefficients with a quantization step size (Qₛₜₑₚ) for associating the transformed coefficients with a finite set of quantization steps. As a quantization step size is not an integer, a quantization parameter QP is used to indicate an associated Qₛₜₑₚ. The relation between the value of the quantization parameter QP and the quantization step size Qₛₜₑₚ may be linear or exponential according to different encoding standards. Taking H.263 as an example, the relationship between the value of QP and Qₛₜₑₚ is that Qₛₜₑₚ˜2×QP. Taking H.264 as another example, the relationship between the value of QP and Q step is that Qₛₜₑₚ˜2^{Q/P16}.

It is understood that the encoding process, especially the quantization module, affects the image quality of an image frame or a block. An image quality is typically indicated by the bit rate of a corresponding image or a block. A higher bit rate suggests a high image quality of an encoded image or block. According an embodiment, the present application adjusts the image quality of an encoded image or block by controlling the bit rate of the encoded video data.

The adjustment of the bit rate can be further achieved by adjusting the value of a coding parameter, such as the quantization parameter. Smaller values of the quantization parameter QP, which is associated with smaller quantization step size Qₛₜₑₚ, can more accurately approximate the spatial frequency spectrum of the residual block, i.e., more spatial detail can be retained, thus producing more bits and higher bit rates in the encoded data stream. Larger values of QP represent coarser step sizes that crudely approximate the spatial frequency spectrum of the residual block such that less of the spatial detail of residual block can be reflected in the encoded data. That is, as the value of QP increases, some spatial detail is aggregated that causes spatial details to be lost or blocked, resulting in a reduction of the bit rate and image quality.

For example, H.264 allows a total of 52 possible values of quantization parameters QP, which are 0, 1, 2, . . . , 51, and each unit increase of QP lengthens the Qₛₜₑₚ by 12% and reduces the bit rate by roughly 12%. In an embodiment, the encoder determines values of the quantization parameters QP corresponding to each transformation coefficient of each macroblock to control a target quality and/or bit rate. In another embodiment, the encoder assigns a maximum value of the quantization parameter QP for each macroblock in ROIs to ensure the quality of the ROI. Once the maximum value of QP is set, the image quality of the encoded data is shielded from influence of other factors such as available bandwidth and context of the image frame. In another embodiment, the encoder adjusts the maximum value of QP for each macroblock in ROIs according to changes of the bandwidth and context of the video.

In the entropy encoding module 305, the quantized transform coefficients are entropy encoded. In some embodiments, the quantized transform coefficients may be reordered (not shown) before entropy encoding. The entropy encoding can convert symbols into binary codes, e.g., a data stream or a bitstream, which can be easily stored and transmitted. For example, context-adaptive variable-length coding (CAVLC) is used in H.264 standard to generate data streams. The symbols that are to be entropy encoded include, but are not limited to, the quantized transform coefficients, information for enabling the decoder to recreate the prediction (e.g., selected prediction mode, partition size, and the like), information about the structure of the data stream, information about a complete sequence (e.g., MB headers), and the like.

In some embodiments, as shown in FIG. 3, the “inverse path” includes an inverse quantization module 306, an inverse transformation module 307, and a reconstruction module 308. The quantized transform coefficients are inversely quantized and inversely transformed to generate a reconstructed residual block. The inverse quantization is also referred to as a re-scaling process, where the quantized transform coefficients are multiplied by Qₛₜₑₚ to obtain rescaled coefficients, respectively. The rescaled coefficients are inversely transformed to generate the reconstructed residual block. An inverse transformation method corresponding to the transformation method used in the transformation module 303 can be used here. The reconstructed residual block is added to the predicted block in the reconstruction module 308 to create a reconstructed block, which is stored in the context 301 as a reference for prediction of the next block.

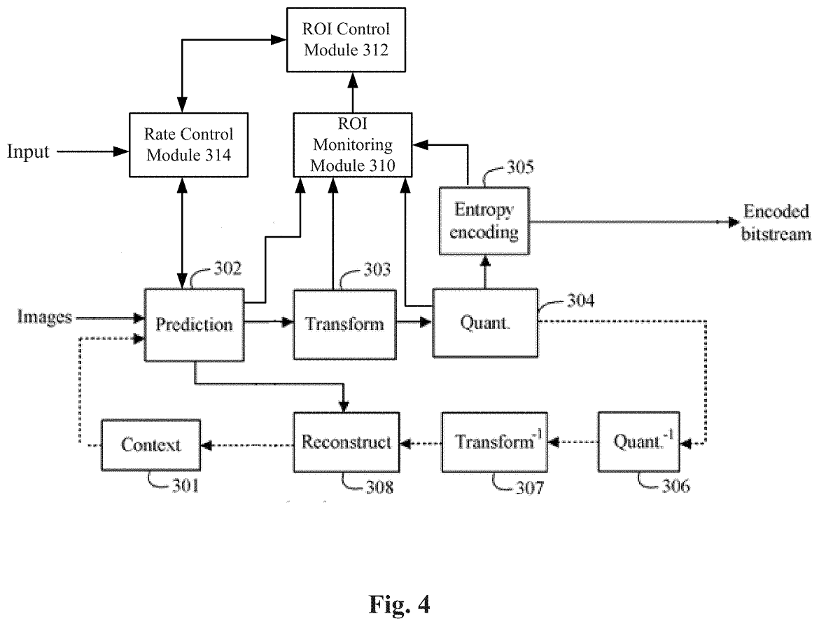

FIG. 4 illustrates an encoder according to an embodiment of the present application. In comparison with FIG. 3, the encoding system in FIG. 4 includes several additional modules such as a ROI monitoring module 310, a ROI control module 312, and a rate control module 314. The ROI monitoring module 310 receives encoding parameters from the prediction module, the DCT module, the quantization module, and the entropy coding module, estimates image qualities of ROIs and non-ROIs, and outputs the estimated image quality to the ROI control module. The ROI control module adjusts parameters of ROIs and/or non-ROIs according to the estimated image quality input from the ROI monitoring module and outputs the adjusted parameters to the rate control module 314. The rate control module 314 is configured to allocate bit rates to ROIs and non-ROIs according to the complexity of the image, the input from an operator, and/or the ROI control module 312, under the constraints of the network conditions, such as the available bandwidth.

The ROI monitoring module 310 is designed to monitor the quality of the encoded frame images and is coupled to a plurality of the processing modules of the encoding system, including the prediction module, the transform module, the quantization module, and the entropy coding module, to collect encoding parameters used by each module. For example, the ROI monitoring module may receive from the prediction module parameters about prediction modes and the type and size of macroblocks. In an embodiment, the ROI monitoring module 310 receives parameters of ROIs, such as location, size, and shape of ROIs and the identification of macroblocks that are in the ROIs. In another embodiment, the ROI monitoring module receives from the transformation module parameters about the transformation functions, receives from the quantization parameters the quantization parameters of each macroblock, and receives from the entropy encoding module algorithms used for the encoding and bit rates of the encoded frame image.

The ROI monitoring module 310 is configured to estimate image qualities of ROIs and non-ROIs based on the encoding parameters received from other modules and then provide the estimated image qualities to the ROI control module 309 for adjusting ROIs. A function of the ROI monitoring module 310 is to process encoding parameters of ROIs and non-ROIs of an image frame with statistical algorithms and calculate a statistical value as an indicator of the image quality of the ROIs and non-ROIs. In an embodiment, the ROI monitoring module 310 treats the quantization parameter QP as an indicator of the image quality of ROI. The ROI monitoring module 310 first groups those quantization parameters according to non-ROIs and ROIs and compares those two grouped quantization parameters. In an embodiment, the ROI monitoring module 308 implements statistical algorithms on each group and compares the obtained statistical results. For example, the ROI monitoring module 310 may calculate an average, mean, median, or weighted average of the quantization parameters in each group. In an embodiment, the ROI monitoring module 310 utilizes a weighted or unweighted histogram to calculate an average of the quantization parameters in each group. In another embodiment, an aggregated quantization parameter in each group is calculated to indicate the image quality. The present application is not limited to only one ROI and/or one non-ROI, but is equally applicable to a plurality of ROIs and/or a plurality of non-ROIs.

The ROI control module 312 receives the estimated image quality from the ROI monitoring module 310 and adjusts ROIs and their encoding parameters accordingly. In an embodiment, the encoding parameters of ROIs include size, location, and shape of the ROIs. In another embodiment, the encoding parameters of ROI also includes an upper limit and a lower limit of the size of the ROIs and an upper limit and a lower limit of the quantization parameters of the ROIs. The upper limit of the size of the ROIs may be the full image frame. The lower limit on the size of the ROIs may be determined based on the application of the encoding device. For example, when a UAV with an encoding device is used for a high speed drone racing, the lower limit may be about 20% of the image frame, which covers a large portion of the middle area of an image frame. The upper limit and the lower limit of the quantization parameter may be determined according to the encoding standard used by the encoding device.

The purpose of to adjust ROIs is to ensure that the image quality of the video data will be balanced between ROIs and non-ROIs with a guaranteed high quality in the ROIs. The upper limit assigned to the quantization parameter QP requires that the quantization step size is no greater than a maximum value such that the image quality of the encoded ROIs will not be easily affected by the context of the image frame and the network conditions, such as bandwidth. As the image quality of ROIs is relatively set due to the limits on the quantization parameters, the adjustment of ROIs will first adjust the size of ROIs to balance the image quality between ROIs and non-ROIs. When the size of ROIs reaches a respective limit, the ROI control module 312 then adjusts the limits of the quantization parameters if a further reallocation of bit rates between ROIs and non-ROIs is required.

In an embodiment, the ROI control module 312 determines the size, shape, and location of ROI in an image frame. The ROI control module 312 receives the video data and displays the video data on a display screen for an operator to indicate their regions of interests. The operator may select one or more regions as ROIs. In an embodiment, the ROI control module 312, after receiving the video data, detects a plurality of objects in an image frame and indicates those objects to the user for the selection of ROIs. These objects may include any recognizable feature in an image frame, such as a human being, an animal, a distinctive color, and etc. This ROI setting method may be suitable for applications such as surveillance, search and rescue, object tracking, and obstacle avoidance. Algorithms for image-based object detection and reorganization are well-known in the art and will not be explained in detail in the present application.

In another embodiment, the ROI control module 312 assigns a region of a predetermined size around a center of the image frame as a ROI as a default ROI. The central region of an image frame is likely to be a naturally focused area of an operator, especially during a drone racing application. In another embodiment, the ROI control module 312 may detect a gaze of the eyes of the operator and assigns a region around the gazing point of the operator as a ROI. In another embodiment, when a drone racer is allowed to test a fight course before the actual racing event, the ROI control module 312 is capable of recognizing obstacles along the flight course and assigning regions around those detected obstacles as ROI.

In another embodiment, the shape of the ROI is not limited to any particular shape. It may be a simple shape such as a rectangle or a circle. It may be a shape that is drew on a display screen by an operator. It may be any shape that closely tracks the contours of a detect object. In another embodiment, the size of an ROI has a lower limit and an upper limit. For example, the lower limit may be about 20% of the size of the image frame, and the upper limit may be the full size of the image frame. The size of the ROI may be in units of macroblocks. For example, for an image frame having 1280×720 pixels, the image frame may be divided into 80×45 macroblocks, among which each macroblock is formed by 16×16 pixels. A predetermined ROI may be a rectangular region around the center of the image and is formed by 40×22 macroblocks. In another embodiment, the ROI controlling module 309 adjusts the size of a ROI according to a plurality of predetermined criteria, which will be described later in the present application.

In addition to adjusting the location, size, and shape of ROIs, the ROI control module also adjusts encoding parameters associated with encoded data to balance the quality between ROIs and non-ROIs. In an embodiment, the ROI control module adjusts the quantization parameters QP of the ROIs and non-ROIs. The adjustment of the quantization parameters is at least based on the data of the ROI monitoring module 310 and network conditions, such as bandwidth.

In an embodiment, both the ROI monitoring module 310 and the ROI control module 312 have a different processing rate. For example, the ROI monitoring module only needs to update its estimation of image qualities once the other modules, such as the transformation module and the quantization module, complete their processing on the respective image frames. Thus, it is acceptable that the ROI monitoring module updates its processing at a frame rate of the video data, which is approximately the same rate of the other components. In an embodiment, the ROI control module has a higher processing rate than the frame rate such that the adjustment of the ROIs and encoding parameters is implemented in real time. For example, if the frame rate of the video data is 120 Hz, the processing rate of the ROI control module may be at least 1200 Hz or even higher.

The rate control module 314 is designed to allocate bit rates according to the encoding parameters of ROIs and non-ROIs. To allocate the bit rates, the rate control module 314 will receive inputs from the operator who may manually adjust ROIs, inputs from the prediction module about prediction modes and image context, inputs from ROI control module about adjusted ROIs, and inputs from a network device about network conditions. In an embodiment, the rate control module first calculates the bit rates of ROIs based on the adjusted ROIs and the inputs from the prediction module. In an embodiment, the rate control module 314 needs not to consider the network conditions during the process of allocating bit rates to ROIs. In an embodiment, the rate control module 314 compares the quantization parameters of ROIs with the corresponding limit and resets a quantization parameter to the lower limit or the upper limit if that quantization parameter is outside the limits. For non-ROIs, their bit rates are set to be the difference between the available bandwidth and the bit rate of the ROIs by the rate control module 314, which further determines the quantization parameters in order to generate the target bit rate of the non-ROIs. The rate control module 314 outputs the rate allocation and calculated quantization parameters to prediction module so that they will be used in the subsequent encoding process.

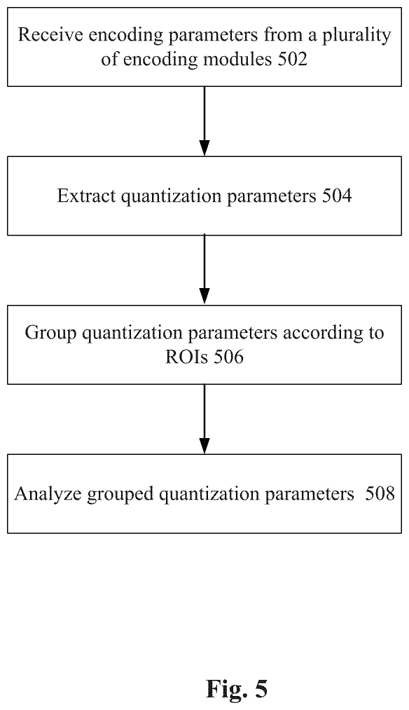

FIG. 5 illustrates an embodiment of a ROI monitoring method of the ROI monitoring module 310. At step 502, the ROI monitoring method receives encoding parameters from a plurality of sources, including the prediction module, the transformation module, the quantization module, and the entropy encoding module. In an embodiment, the encoding parameters include information of ROIs, such as its location, shape, size, and macroblocks within those ROIs. The encoding parameters also include quantization parameters of each macroblock. At step 504, the ROI monitoring method extracts the information of ROIs and their quantization parameters QP. At step 506, the ROI monitoring method groups the extracted quantization parameters according to the ROIs. In one embodiment, quantization parameters of all non-ROIs are placed in one group, and quantization parameters of all ROIs are placed in another group. At step 508, the grouped quantization parameters are processed with statistical algorithms to calculate a statistical value. The statistical value may be any one selected from the group of average, weighted average, median, mean, minimum, and maximum of a quantization parameter. In another embodiment, step 508 may process a plurality of statistical values to calculate a comprehensive indicator of image quality of each group. The step 508 further outputs the statistical values, information of ROIs, and estimated image quality to the ROI control module 312.

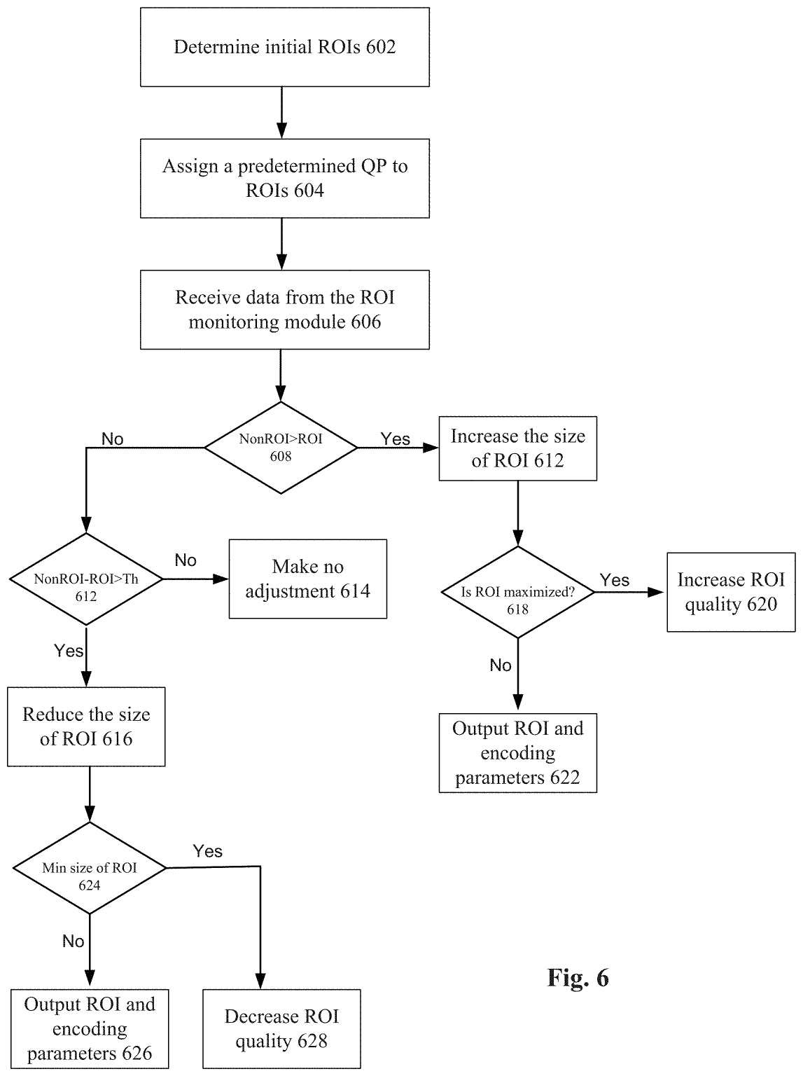

FIG. 6 illustrates an embodiment of a ROI control method of the ROI control module 312 according to the present application. At step 602, the ROI control method sets initial ROIs according to a plurality of methods. For example, step 602 may receive inputs on a display screen by an operator and set initial ROIs according to the inputs by the operator. The inputs may be an area on the display screen that is drawn by the operator, coordinates input by the operator, or an object within the image frame as indicated by the operator. To detect an object of an image frame, step 602 may implements a plurality of automatic recognition algorithms to recognize objects and human figures in the image frame and designate those recognized objects and human figures as initial ROIs. Examples of the recognition algorithms include edge matching, grayscale matching, gradient matching, pose clustering, scale-invariant feature transform, and similar algorithms. In another embodiment, step 602 may also set a region around a center point of a frame as initial ROIs. This embodiment is designed to designate a fixed and naturally focused part of an image frame as an ROI, which avoids unnecessary distraction to an operator due to ROIs that are dynamically moving from an image frame to another. This centrally located ROI may be preferred in the application of drone racing as a player's attention will concentrate on the center of the display screen. In another embodiment, step 602 selects which ROI determining method may be applied depending on the application of an UAV. For example, when an UAV is used for fire rescue and reconnaissance, the operator may not know which object may be of interests. Thus, step 602 uses a recognition algorithm to detect objects in image frames and sets those objects as ROIs. When an UAV is used for a tracking application, step 602 will rely on the input of the operator to designate an object as an ROI. When an UAV is used for drone racing, step 602 may use a centrally located zone as an ROI.

At step 604, a plurality of predetermined limits are set for the ROIs. In an embodiment, a predetermined upper limit of the quantization parameters is assigned to the initial ROIs. This upper limit will cause quantization parameters QP of each macroblock of the ROI to be no greater than the predetermined value. As discussed before, a quantization parameter QP can control the image quality of the ROIs. A lower QP will generate a higher image quality. Thus, the adoption of the upper limit of the quantization parameter also sets a minimum image quality of the ROIs and shields the image quality of ROIs from variations of the network conditions and image context. This predetermined upper limit may be determined in several methods. In an example, this upper limit is determined based on the bandwidth and the size of the ROI. For example, when the size of an ROI is about 20% of the image frame, step 604 may select a value of the limit that causes about 30% of the bandwidth to be assigned to the ROI. In another example, the QP limit of ROIs may be set to no greater than 20.

As discussed before, the size of the ROIs also has an upper limit and a lower limit, which are set at step 604. When the size of ROIs that will be dynamically adjusted by the ROI controlling method reaches either the upper limit or the lower limit of the size, it indicates that adjustments other than the size of ROIs are needed to generate encoded image data with acceptable qualities. In an embodiment, when ROIs reach their size limits, the predetermined limit of the quantization parameters of ROIs will be adjusted. For example, when the ROIs have reached the upper limit of the size, the upper limit of the quantization parameters may be lowered to continue the trend of increasing the bit rate of ROIs. On the other side, when the ROIs have reached the lower limit of the size, the upper limit of the quantization parameters may be increased to continue the trend of lowering the bit rate of ROIs.

At step 606, the ROI control method receives data from the ROI monitoring module 606 and initiates a plurality of processing to determine whether to adjust the size of ROIs or to adjust the limit on the quantizing parameters of ROIs. The received data includes the estimated image quality of ROIs and non-ROIs, statistical values of quantization parameters, and information of ROIs.

At step 608, it is first determined whether the image quality of non-ROIs is better than ROIs. If the answer to step 608 is “Yes,” it shows an unnecessarily high bit rate has been allocated to non-ROIs, suggesting that the bit rate needs to be reassigned such that ROIs will have the higher image quality. Then at step 612, the size of the ROIs is increased by a predetermined step. In this way, the ROIs are enlarged to have more image areas to be encoded with higher quality. The increase of the size of ROIs will produce better visual representations to the operator. After the size of the ROIs is increased, it is further determined at step 618 whether the size of ROIs has reached its maximum or upper limit, such as the fully image frame. If the answer to step 618 is “Yes,” it suggests that the size of ROI may not be increased anymore. As a result, other parameters may be adjusted to increase the image quality of ROIs at step 620. For example, the quantization parameter limit may be reduced to increase the image quality of ROIs. If the answer to step 618 is “No,” then the adjusted size of ROI is acceptable and may be output to the quantization module at step 622.

If the answer to step 608 is “No,” it suggests that the non-ROIs have already had a lower quality than the ROIs. Although it is generally acceptable that non-ROIs have a lower image quality, there may be situations where the image quality of the non-ROIs is too low that negatively affects the visual effects of the entire image frame. Therefore, according to an embodiment of the present application, the ROI control method is further designed to keep the quality difference between non-ROIs and ROIs within a predetermined threshold, Th, to ensure that the image quality of non-ROIs is also acceptable. At step 612, it is determined whether the image quality of non-ROIs is lower than the ROIs by the predetermined threshold Th. If the answer to step 612 is “No,” it means that the image qualities of ROIs and non-ROIs are not too apart from each other and are acceptable. Thus, no adjustment of the ROI or the encoding parameter is needed at step 614.

But if the answer to step 612 is “Yes,” it suggests that the image quality of the non-ROIs may be too low in comparison with the ROIs. Thus, to improve the quality of the non-ROIs, the size of ROIs is reduced at step 616 to save more bit rates for the non-ROIs according to an embodiment of the present application. As the size of ROIs is reduced, step 624 determines whether the size of the ROIs has reached the lower limit or not. If the size has reached the lower limit of the ROIs, then step 628 increases the limit of quantization parameters of ROIs to allow more bit rates to be reassigned from the ROIs to the non-ROIs. But if the size of ROIs has not reached the lower limit, then the size and the encoding parameters of ROIs are acceptable and are output to the quantizing module at step 626.

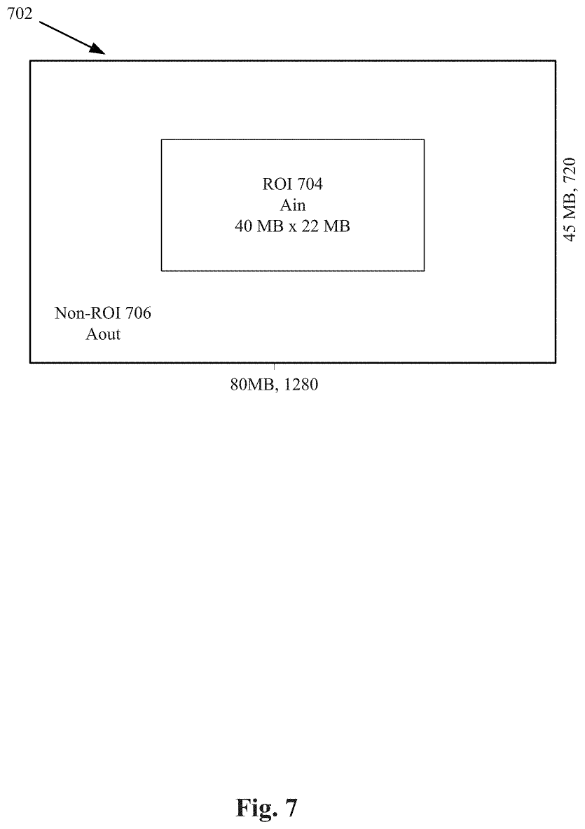

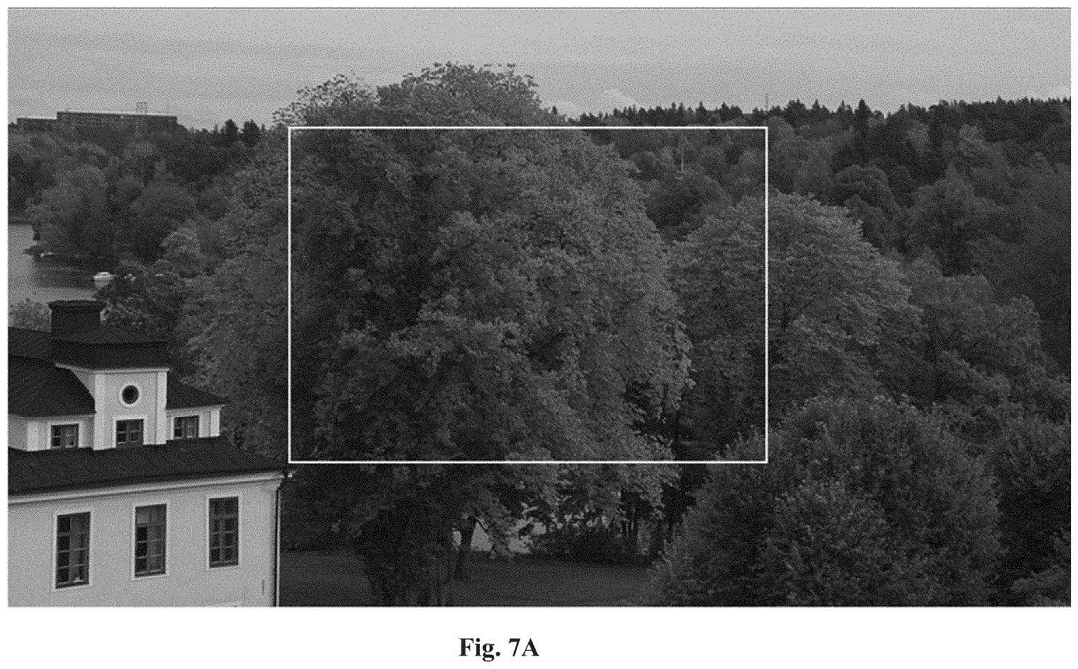

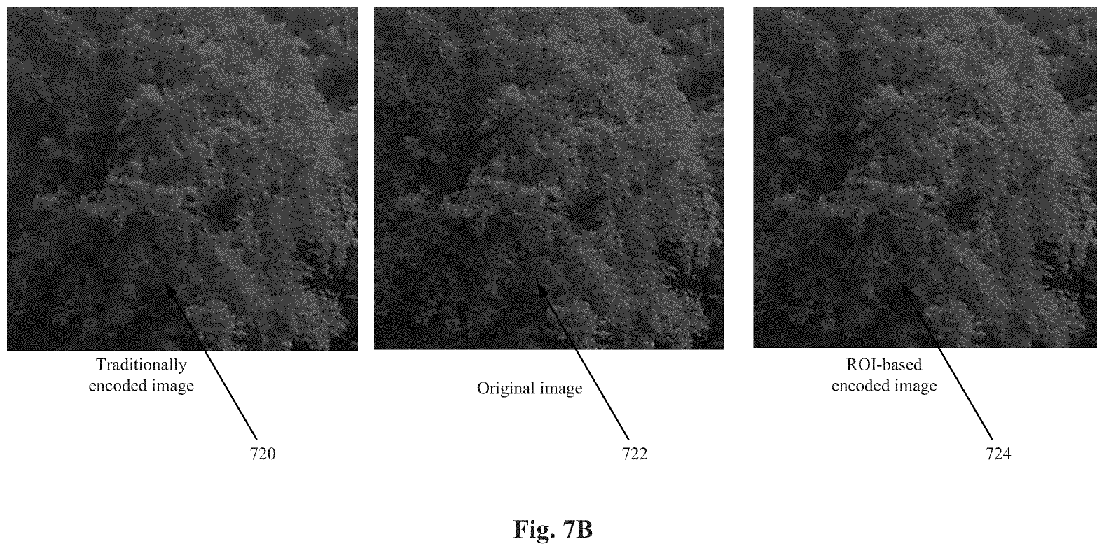

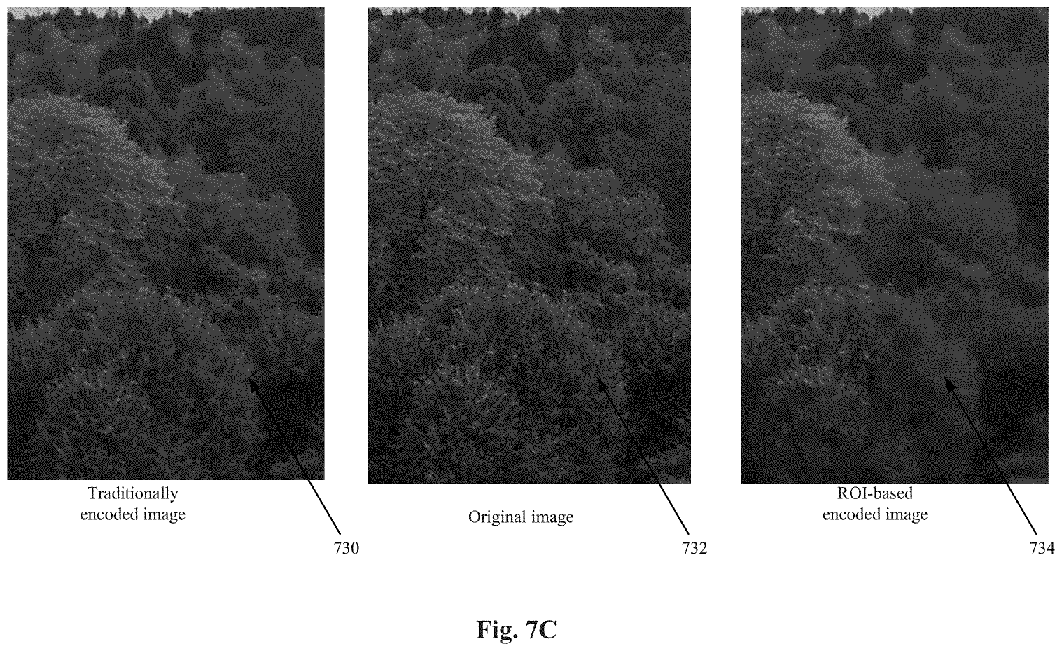

FIG. 7 illustrates an image frame with an ROI according to an embodiment. The image frame 702 has a resolution of 1280×720. During encoding, the image frame 702 is divided into a plurality of macroblocks, each having 16×16 pixels. As a result, the image frame may be understood to be formed by a matrix of 80 (1280/16=80) by 45 (720/16=45) macroblocks. An initial ROI 704 is set to be a rectangle centrally located in the image frame and formed by 40×22 macroblocks, which is approximately about 25% of the area of the image frame. An upper limit of the ROI is set to be the full image frame and the lower limit of the ROI is set to be 20×10 macroblocks, which is approximately about 1/16 of area of the image frame. A maximum quantization parameter is further assigned to the ROI, such as QP<=20, while the quantization parameters of the non-ROIs 706 are left for the encoding algorithm to assign. The encoding algorithm will encode the ROI first and determines an approximate bit rate of the ROI based on the assigned quantization parameters, which cannot exceed the assigned maximum value. After the ROI is encoded, the encoding algorithm calculates a target bit rate, which is determined based on the difference between the available bandwidth and the bit rate of the ROI, and assigns the target bit rate to the non-ROI and then encode the non-ROI to generate the target bit rate.

After the image frame 702 is encoded, the quantization parameters of the ROI 704 and non-ROI 706 are extracted and grouped accordingly. A weighted average quantization parameter WQP is calculated according to the following equations for both the ROI and non-ROI, respectively.

(1) Obtain histograms of quantization parameters of the ROI and non-ROI, respectively.

For qpⱼ in the non-ROI, Out_Histogram [qpⱼ]=Out_Histogram [qpⱼ]+1;

For qpⱼ in the ROI, In Histogram [qpⱼ]=In Histogram [qpⱼ]+1;

(2) Calculate a weighted average quantization parameters wqp for the ROI and non-ROI, respectively.

For each 0<=qpⱼ<=51 (the QP values in H.264),

qpSum=qpSum+Histogram [qpⱼ]×qpⱼ

nSum=nSum+Histrogram [qpⱼ]

Weighted average quantization parameter wqp=qpSum/nSum.

(3) Adjust the ROI and quantization parameters according to the weighted average wqp.

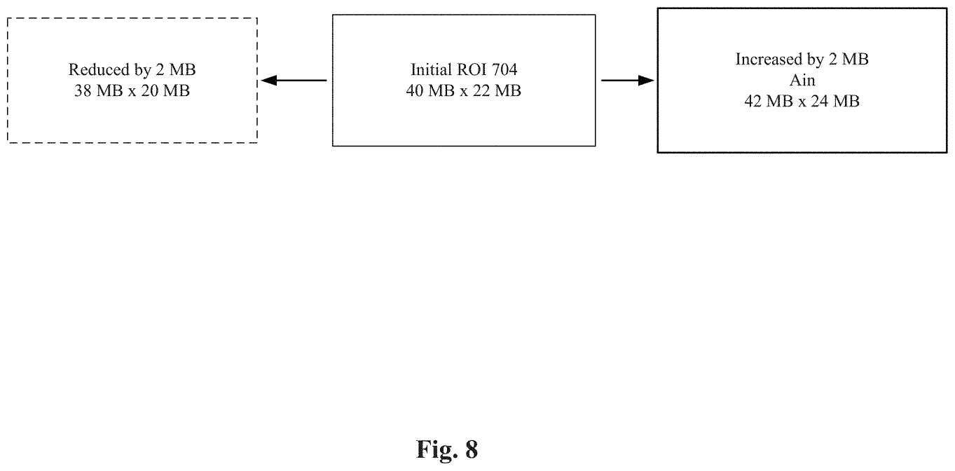

The value of a weighted average wqp is shown in FIG. 7 as Aᵢₙ and the non-ROI has a wqp value of Aₒᵤₜ. FIG. 8 illustrates the adjustment of the size of ROI according to an embodiment of the present application. If Aₒᵤₜ is less than Aᵢₙ then it is deemed that the non-ROI has an image quality higher than the ROI, which requires adjustment to assign more bit rates to the ROI. Thus, the size of the ROI may be increased by a predetermined step, such as two macroblocks, which increases the size of the initial ROI from 40×22 macroblocks to 42×24 macroblocks. The increase of the ROI may continue until the ROI reaches the full image. In that situation, the maximum value of the quantization parameter of the ROI may be lowered by a predetermined value, such as three, to further increase the image quantity of the ROI.

But if Aₒᵤₜ is between Aᵢₙ and Aᵢₙ+Threshold, it suggests that the image quality of the non-ROI is lower than the ROI and is within a predetermined threshold from the ROI, then the encoding result is acceptable, and no adjustment is needed.

But if Aₒᵤₜ is even greater than Aᵢₙ+Threshold, Th, it suggests that the image quality of the non-ROI is much worse than the ROI and adjustment of the encoding parameters is proper. In an embodiment, the Threshold, Th, is selected according to the encoding standard adopted by the encoding system. The selected Threshold, Th, may indicate a doubled image quality. In an embodiment, the encoding system of the present application implements the H.264 encoding standard, and Aᵢₙ/Aₒᵤₜ are the mean values of the quantization parameters of ROIs/NonROIs. As a result, the Threshold, Th, is selected to be 6, which represents a doubled image quality, or 12, which represents a quadrupled image quality. When the image qualities between the ROIs and non-ROIs have a huge gap, the adjustment of the size of the ROIs will take a higher priority than other ways to balance the image qualities of the ROIs and non-ROIs. For example, the size may be reduced by a predetermined step, such as two macroblocks, which results in a new ROI of 38×20 macroblocks. When the new ROI reaches the preset lower limit, such as 20 by 10 macroblocks, the maximum value of quantization parameters in the ROI is increased by a predetermined amount, such as three, to further save more bit rate for the non-ROI. In an embodiment, the size of ROIs in a frame image may be adjusted only once to avoid any abrupt change of ROIs. In another embodiment, the size of the ROIs in one frame image may be adjusted a plurality of time until image qualities in ROIs and non-ROIs satisfy the requirements of the criteria as set forth in the present application.

FIG. 7A-C illustrate a work example according to an embodiment of the present application. FIG. 7A illustrates an original image that has not been encoded or compressed. The fine details of objects in this original image are still discernable, such as those leaves and shades inside the tree at the center of the image. The white box in the image illustrates where a ROI is located.

FIG. 7B illustrates that, in the ROI region, the encoding method according to the present application preserves the image quality much better than the traditional coding method. The image at the center shows the ROI region of the original image. The images left and right to the center image illustrate the encoded ROI region by the method according to the present application and a traditional method, in which the image at the right to the center image shows the ROI region encoded by the ROI-based encoded method and the image at the left to the center image shows the ROI region encoded by a traditional method. As shown in FIG. 7B, the leaves and shades inside the tree in the ROI-based encoding image 724 preserves more details than those of the traditionally encoded method 720. The ROI 724 also closely tracks what is shown in the original image 722. Thus, the ROI-based encoding method according to the present application generates a better image quality in the ROI region than the traditional methods.

FIG. 7C illustrates the image quality of non-ROI regions between the ROI-based encoding method and the traditional method. The image at the center shows the right portion region of the original image, which is a non-ROI region. The images left and right to the center image illustrate the encoded non-ROI region by the method according to the present application and a traditional method, in which the image at the right to the center image shows the non-ROI region encoded by the ROI-based encoded image and the image at the left to the center image shows the non-ROI region encoded by a traditional method. As shown in FIG. 7C, the leaves and shades inside the tree in the ROI-based encoded image 734 lost more details than those of the traditionally encoded image 730. These image shows that the ROI-based encoding method according to the present application has made more reallocation of bit rates from the non-ROI region to the ROI region in this particular instance.

In general, functionality of the encoder as disclosed in the present application could be implemented by hardware, software or a combination thereof. For example, the operation of those encoding modules could be performed in whole or in part by software which configures a processor of the encoder to implement the encoding methods as set forth in the present application. Suitable software will be readily apparent to those skilled in the art from the description herein. For reasons of operating speed, the use of hardwired logic circuits is generally preferred to implement encoding functionality.

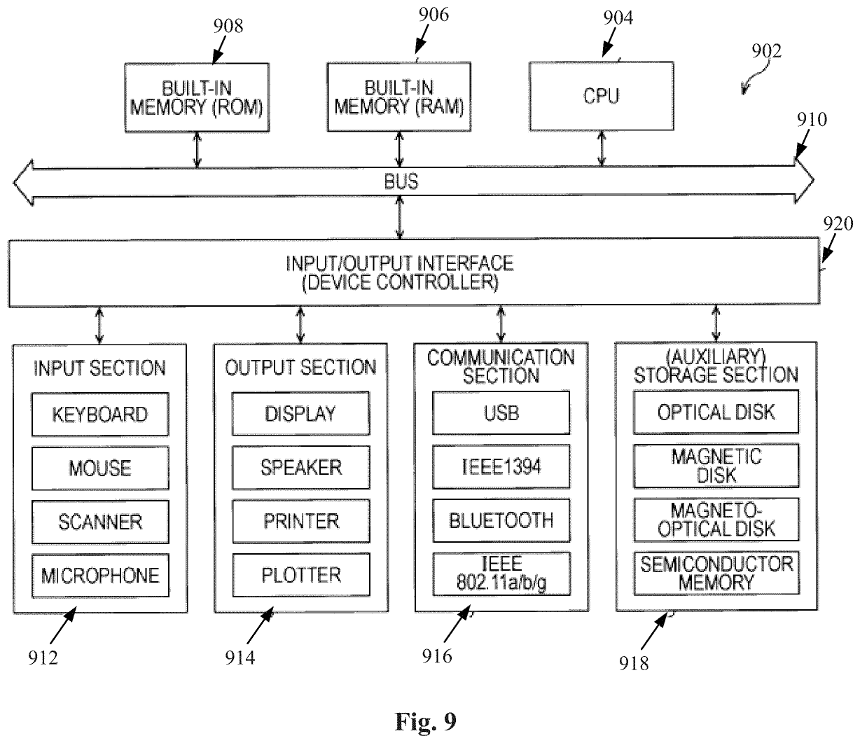

FIG. 9 illustrates an exemplary electronic device that is capable of implementing the encoding method according to the present application. The electronic device 902 includes a CPU 904, a built-in RAM 906, and a built-in ROM 908, which are interconnected through a bus 910. Various functional sections are also connected to the bus 910 via an input/output interface 920. The functional sections for the electronic device 902 include an input section 912, an output section 914, a communication section 916, and an auxiliary storage section 918. Examples of the input section 912 include a keyboard, a mouse, a scanner, a microphone, or a touch-sensitive display screen. Examples of the output section 914 include a display, a speaker, a printer, or a plotter. Examples of the communication section 916 include a USB interface, an IEEE 1394 interface, a Bluetooth interface, or an IEEE 802.11a/b/g interface. Examples of the auxiliary storage section 918 include an optical disk, a magnetic disk, a magneto-optical disk, or a semiconductor memory. A FAT file system may be used for each storage medium included in the auxiliary storage section 918 for the electronic device 902, and data is recorded to each storage medium in the same manner. Examples of the electronic device may be a computer, a server, a client terminal, a mobile electronic device, a table, or a phone.

A non-transitory storage medium as used in the present application for storing an executable program may include any medium that is suitable for storing digital data, such as a magnetic disk, an optical disc, a magneto-optical disc, flash or EEPROM, SDSC (standard-capacity) card (SD card), or a semiconductor memory. A storage medium may also have an interface for coupling with another electronic device such that data stored on the storage medium may be accessed and/or executed by other electronic device.

While this invention has been described in conjunction with the specific embodiments outlined above, it is evident that many alternatives, modifications, and variations will be apparent to those ordinarily skilled in the art. Accordingly, the embodiments of the invention as set forth above are intended to be illustrative, not limiting. Various changes may be made without departing from the spirit and scope of the inventions as defined in the following claims.

1. An unmanned aerial vehicle comprising:
a body coupled with a propulsion system and an imaging device;
an encoder for encoding video data generated by the imaging device, the encoder including:
a region of interest (ROI) control module that determines, within an image frame of the video data, a first region and a second region, the ROI control module further setting a first limit indicating a maximum value of quantization parameters for encoding each macroblock within the first region, a second limit indicating a maximum size of the first region, and a third limit indicating a minimum size of the first region; and
a ROI monitoring module coupled to the ROI control module that estimates a first image quality of the video data of the first region and a second image quality of the video data of the second region; and
a wireless communication system for transmitting the video data encoded by the encoder,
wherein the ROI control module adjusts sizes of the first region and the second region according to the first image quality and the second image quality.

2. The unmanned aerial vehicle according to claim 1, wherein the ROI monitoring module calculates a first statistical value based on the quantization parameters of each macroblock within the first region as the first image quality and calculates a second statistical value based on quantization parameters of each macroblock within the second region as the second image quality.

3. The unmanned aerial vehicle according to claim 2, wherein, when the second image quality is greater than the first image quality, the ROI control module increases the size of the first region by a predetermined length.

4. The unmanned aerial vehicle according to claim 3, wherein, when the size of the first region reaches the second limit and the second image quality is greater than the first image quality, the ROI control module reduces the first limit by a predetermined amount.

5. The unmanned aerial vehicle according to claim 2, wherein, when the second image quality is lower than the first image quality by a predetermined threshold, the ROI control module reduces the size of the first region by a predetermined length.

6. The unmanned aerial vehicle according to claim 5, wherein, when the size of the first region reaches the third limit and the second image quality is lower than the first image quality by the predetermined threshold, the ROI control module increases the first limit by a predetermined amount.

7. The unmanned aerial vehicle according to claim 5, wherein, when the second image quality is not lower than the first image quality by the predetermined threshold, the ROI control module keeps both the size of the first region and the first limit unchanged.

8. The unmanned aerial vehicle according to claim 1, wherein the first region represents a rectangle of a predetermined size that surrounds a center of the image frame, and a combination of the first region and the second region occupies a full image frame.

9. The unmanned aerial vehicle according to claim 1, wherein the ROI control module implements an object recognition algorithm to determine the first region.

10. The unmanned aerial vehicle according to claim 1, wherein the encoder estimates a first bit rate of the encoded video data corresponding to the first region by encoding the first region, calculates a second bit rate of the second region based on the first bit rate and an available bandwidth of the wireless communication system, and encodes the video data of the second region to fit the target bit rate.

11. A method for encoding video data comprising:
receiving the video data generated by an imaging device,
determining, within an image frame of the video data, a first region and a second region;
setting a first limit indicating a maximum value of quantization parameters for encoding each macroblock within the first region, a second limit indicating a maximum size of the first region, and a third limit indicating a minimum size of the first region;
estimating a first image quality of the video data of the first region and a second image quality of the video data of the second region;
adjusting a size of the first region and the second region according to the first image quality and the second image quality; and
encoding the video data.

12. The method according to claim 11, further comprising:
calculating a first statistical value based on the quantization parameters of each macroblock within the first region as the first image quality and calculating a second statistical value based on quantization parameters of each macroblock within the second region as the second image quality.

13. The method according to claim 12, further comprising:
when the second image quality is greater than the first image quality, increasing the size of the first region by a predetermined length.

14. The method according to claim 13, further comprising:
when the size of the first region reaches the second limit and the second image quality is greater than the first image quality, reducing the first limit by a predetermined amount.

15. The method according to claim 12, further comprising:
when the second image quality is lower than the first image quality by a predetermined threshold, reducing the size of the first region by a predetermined length.

16. The method according to claim 15, further comprising:
when the size of the first region reaches the third limit and the second image quality is lower than the first image quality by the predetermined threshold, increasing the first limit by a predetermined amount.

17. The method according to claim 15, further comprising:
when the second image quality is not lower than the first image quality by the predetermined threshold, keeping both the size of the first region and the first limit unchanged.

18. The method according to claim 11, wherein the first region represents a rectangle of a predetermined size that surrounds a center of the image frame, and a combination of the first region and the second region occupies a full image frame.

19. The method according to claim 11, further comprising:
implementing an object recognition algorithm to determine the first region.

20. The method according to claim 11, further comprising:
estimating a first bit rate of the encoded video data corresponding to the first region by encoding the first region;
calculating a second bit rate of the second region based on the first bit rate and an available bandwidth of a wireless communication system; and
encoding the video data of the second region to fit the target bit rate.

21.-30. (canceled)
